(19) United States
(12) Patent Application Publication
(10) Pub. No.: US 2013/0047822 A1
(43) Pub. Date: Feb. 28, 2013

(54) SYSTEMS AND METHODS FOR ALLOWING MULTIPLE SINGERS OF DIFFERENT ENVIRONMENTS TO JOIN IN A SAME SONG SIMULTANEOUSLY

(71) Applicant: Yat Wai Edwin Kwong, Hong Kong (HK)

(72) Inventor: Yat Wai Edwin Kwong, Hong Kong (HK)

(21) Appl. No.: 13/217,721

(22) Filed: Aug. 25, 2011

(51) Int. Cl. G10H 7/00

(52) U.S. Cl. 84/609

(57) ABSTRACT

Singing systems and methods are provided for allowing multiple singers of different environments to join in a same song simultaneously. In one embodiment, a singer system is provided. The system comprises a centralized system to control songs playing on different mobile devices; a first mobile device held by a first user; a second mobile device held by a second user; a location detecting device included in the first mobile device to determine a background that should be displayed on the first mobile device; and a language detector included in the first mobile device to detect current language in accordance with the first user's voice; a speed detector included in the first mobile device to detect current speed of song sung currently by the first user.

### FIELD OF THE INVENTION

This invention generally relates to a singing system. Specifically, but not limited to, this invention relates to receiving instructions to play a song; fetching music associated with the song from the centralized system; sending the music associated with the song to the first mobile device; determining the background should be displayed on the first mobile device when playing the song, in accordance with the current location detected by the location detecting device; determining the current language of lyrics that should be displayed on the first mobile device when playing the song, in accordance with the current language associated with the first user's voice, as detected by the language detector detecting device; mixing the music received from the centralized system with the background determined by the first mobile device and the lyrics associated with the current language; playing the mixed music, together with the determined background and the determined lyrics, on the first mobile device; allowing the first user to sing with the playing song; determining whether the first user is singing too slowly, in view of speed of lyrics displayed on the first mobile device; and if determined that the first user is singing too slowly, adjusting the speed of lyrics displayed on the first mobile device and adjust speed of playing the mixed music.

### BACKGROUND OF THE INVENTION

Karaoke is popular in the entertainment industry. Karaoke is usually centralized in a single location, possibly a room, in which a group of people are gathered for singing songs. When a song is played, one or two performers can sing the song by following lyrics displaying on the screen located in the room. The rest of the people in the room can listen the song sung by the one or two performers. Market is huge for the karaoke market. There is however, a greater market for karaoke supporting many people singing at the same time. With the emergence of the mobile devices, singing with many people at the same time can happen. Moreover, the value is very high, given the location of the people is not limited to a single location. Instead, the invention allows multiple people joining a karaoke singing in different places, and adjusting the needs accordingly. The participation of the rest of the people in a karaoke is, however, limited. The conventional way of singing has its disadvantages. For one, the number of people participating in singing the song is limited. Other people must take turn to sing. Also, the person singing a song may not be able to follow the lyrics accurately. Sometimes, the person may be faster than the lyrics. In other times, the person may be slower than the lyrics. Therefore, there is a need for the karaoke system to adjust the flow of a karaoke song, in accordance with the flow of the singer.

### SUMMARY OF THE INVENTION

A singing system is provided for allowing multiple singers of different environments to join in a same song simultaneously. According to embodiments of the invention, a singing system is provided, comprising a centralized system to control songs playing on different mobile devices; a first mobile device held by a first user; a second mobile device held by a second user; a location detecting device included in the first mobile device to determine a background that should be displayed on the first mobile device; a language detector included in the first mobile device to detect current language in accordance with the first user's voice; a speed detector included in the first mobile device to detect current speed of song sung currently by the first user; a processor; and a memory storing instructions that cause the processor to execute a method.

Alternative, in a different embodiment, the inventive method comprises receiving instructions to play a song; fetching music associated with the song from the centralized system; sending the music associated with the song to the first mobile device; determining the background should be displayed on the first mobile device when playing the song, in accordance with the current location detected by the location detecting device; determining the current language of lyrics that should be displayed on the first mobile device when playing the song, in accordance with the current language associated with the first user's voice, as detected by the language detector detecting device; mixing the music received from the centralized system with the background determined by the first mobile device and the lyrics associated with the current language; playing the mixed music, together with the determined background and the determined lyrics, on the first mobile device; allowing the first user to sing with the playing song; determining whether the first user is singing too slowly, in view of speed of lyrics displayed on the first mobile device; and if determined that the first user is singing too slowly, adjusting the speed of lyrics displayed on the first mobile device and adjust speed of playing the mixed music.

In a different embodiment, the system may enable receiving instructions to play a song; fetching music associated with the song from the centralized system; sending the music associated with the song to the first mobile device; determining the background should be displayed on the first mobile device when playing the song, in accordance with the current location detected by the location detecting device; determining the current language of lyrics that should be displayed on the first mobile device when playing the song, in accordance with the current language associated with the first user's voice, as detected by the language detector detecting device; mixing the music received from the centralized system with the background determined by the first mobile device and the lyrics associated with the current language; playing the mixed music, together with the determined background and the determined lyrics, on the first mobile device; allowing the first user to sing with the playing song; determining whether the first user is singing too slowly, in view of speed of lyrics displayed on the first mobile device; if determined that the first user is singing too slowly, stopping playing the song on the first mobile device; adjusting the speed of lyrics displayed on the first mobile device and adjust speed of playing the mixed music; and continuing to play rest of song on the first mobile device with the adjusted speed of lyrics; determining whether the first user is changing language, in view of current language sung in the song by the first user; and if determined that the first user has changed to another language, stopping playing the song on the first mobile device; notifying the central system to send the lyrics of the another language to the first mobile device; mixing the lyrics of the another language with the song; playing the rest of the mixed song to the first mobile device.

Further in the embodiment, the method comprises receiving instructions to play a song; fetching music associated with the song from the centralized system; sending the music associated with the song to the first mobile device; sending the music associated with the song to the second mobile device; determining the background should be displayed on the first mobile device when playing the song, in accordance with the current location detected by the location detecting device of the first mobile device; determining the background should be displayed on the second mobile device when playing the song, in accordance with the current location detected by the location detecting device of the second mobile device; determining the current language of lyrics that should be displayed on the first mobile device when playing the song, in accordance with the current language associated with the first user's voice, as detected by the language detector detecting device; determining the current language of lyrics that should be displayed on the second mobile device when playing the song, in accordance with the current language associated with the second user's voice, as detected by the language detector detecting device of the second mobile device; mixing the music received from the centralized system with the background determined by the first mobile device and the lyrics associated with the current language; mixing the music received from the centralized system with the background determined by the second mobile device and the lyrics associated with the current language; playing the mixed music, together with the determined background and the determined lyrics, on the first mobile device; playing the mixed music, together with the determined background and the determined lyrics, on the second mobile device; allowing the first user to sing with the playing song; allowing the second user to sing with the playing song; determining whether the first user is singing too slowly, in view of speed of lyrics displayed on the first mobile device; determining whether the second user is singing too slowly, in view of speed of lyrics displayed on the second mobile device; if determined that the first user is singing too slowly, stopping playing the song on the first mobile device; adjusting the speed of lyrics displayed on the first mobile device and adjust speed of playing the mixed music; and continuing to play rest of song on the first mobile device with the adjusted speed of lyrics; if determined that the second user is singing too slowly, stopping playing the song on the second mobile device; adjusting the speed of lyrics displayed on the second mobile device and adjust speed of playing the mixed music; and continuing to play rest of song on the second mobile device with the adjusted speed of lyrics; determining whether the first user is changing language, in view of current language sung in the song by the first user; if determined that the first user has changed to another language, stopping playing the song on the first mobile device; notifying the central system to send the lyrics of the another language to the first mobile device; mixing the lyrics of the another language with the song; playing the rest of the mixed song to the first mobile device; determining whether the second user is changing language, in view of current language sung in the song by the second user; and if determined that the first user has changed to another language, stopping playing the song on the second mobile device; notifying the central system to send the lyrics of the another language to the second mobile device; mixing the lyrics of the another language with the song; playing the rest of the mixed song to the second mobile device.

### BRIEF DESCRIPTION OF THE DRAWINGS

FIG. 1 illustrates an exemplary karaoke system, consistent with embodiments of the present invention.

### DETAILED DESCRIPTION

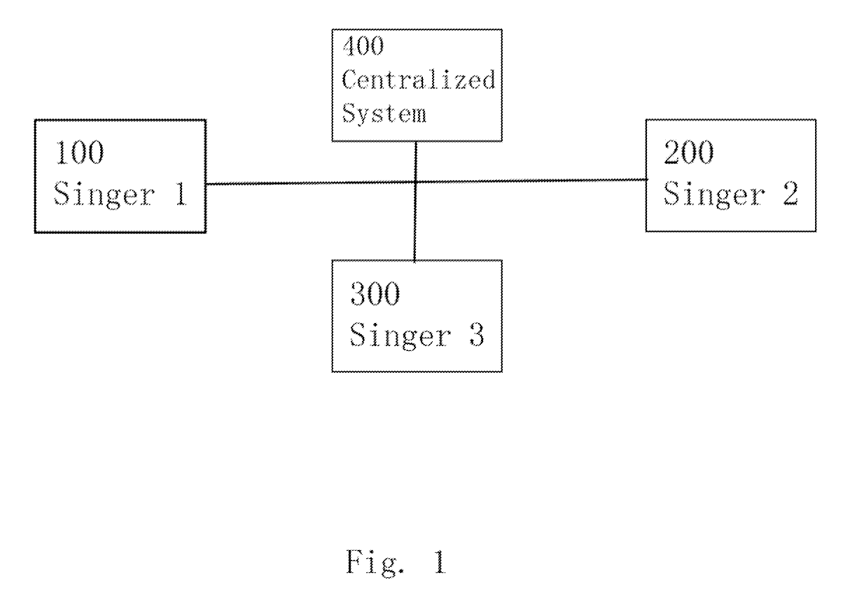

A singing system is provided for allowing multiple singers of different environments to join in a same song simultaneously. In one implementation referring to FIG. 1, the singing system comprises a centralized system to control songs playing on different mobile devices; a first mobile device held by a first user; a second mobile device held by a second user; a location detecting device included in the first mobile device to determine a background that should be displayed on the first mobile device; a language detector included in the first mobile device to detect current language in accordance with the first user's voice; a speed detector included in the first mobile device to detect current speed of song sung currently by the first user; a processor; a memory storing instructions that cause the processor to execute a method, comprising: receiving instructions to play a song; fetching music associated with the song from the centralized system; sending the music associated with the song to the first mobile device; determining the background should be displayed on the first mobile device when playing the song, in accordance with the current location detected by the location detecting device; determining the current language of lyrics that should be displayed on the first mobile device when playing the song, in accordance with the current language associated with the first user's voice, as detected by the language detector detecting device; mixing the music received from the centralized system with the background determined by the first mobile device and the lyrics associated with the current language; playing the mixed music, together with the determined background and the determined lyrics, on the first mobile device; allowing the first user to sing with the playing song; determining whether the first user is singing too slowly, in view of speed of lyrics displayed on the first mobile device; and if determined that the first user is singing too slowly, adjusting the speed of lyrics displayed on the first mobile device and adjust speed of playing the mixed music.

In another example disclosed herein, a singing system is provided for allowing multiple singers of different environments to join in a same song simultaneously. The singing system comprises a centralized system to control songs playing on different mobile devices; a first mobile device held by a first user; a second mobile device held by a second user; a location detecting device included in the first mobile device to determine a background that should be displayed on the first mobile device; a language detector included in the first mobile device to detect current language in accordance with the first user's voice; a speed detector included in the first mobile device to detect current speed of song sung currently by the first user; a processor; a memory storing instructions that cause the processor to execute a method, comprising: receiving instructions to play a song; fetching music associated with the song from the centralized system; sending the music associated with the song to the first mobile device; determining the background should be displayed on the first mobile device when playing the song, in accordance with the current location detected by the location detecting device; determining the current language of lyrics that should be displayed on the first mobile device when playing the song, in accordance with the current language associated with the first user's voice, as detected by the language detector detecting device; mixing the music received from the centralized system with the background determined by the first mobile device and the lyrics associated with the current language; playing the mixed music, together with the determined background and the determined lyrics, on the first mobile device; allowing the first user to sing with the playing song; determining whether the first user is singing too slowly, in view of speed of lyrics displayed on the first mobile device; if determined that the first user is singing too slowly, stopping playing the song on the first mobile device; adjusting the speed of lyrics displayed on the first mobile device and adjust speed of playing the mixed music; and continuing to play rest of song on the first mobile device with the adjusted speed of lyrics; determining whether the first user is changing language, in view of current language sung in the song by the first user; and if determined that the first user has changed to another language, stopping playing the song on the first mobile device; notifying the central system to send the lyrics of the another language to the first mobile device; mixing the lyrics of the another language with the song; playing the rest of the mixed song to the first mobile device.

Furthermore, the singing system may include a first mobile device held by a first user; a second mobile device held by a second user; a location detecting device included in the first mobile device to determine a background that should be displayed on the first mobile device; a language detector included in the first mobile device to detect current language in accordance with the first user's voice; a speed detector included in the first mobile device to detect current speed of song sung currently by the first user; a processor; a memory storing instructions that cause the processor to execute a method, comprising: receiving instructions to play a song; fetching music associated with the song from the centralized system; sending the music associated with the song to the first mobile device; sending the music associated with the song to the second mobile device; determining the background should be displayed on the first mobile device when playing the song, in accordance with the current location detected by the location detecting device of the first mobile device; determining the background should be displayed on the second mobile device when playing the song, in accordance with the current location detected by the location detecting device of the second mobile device; determining the current language of lyrics that should be displayed on the first mobile device when playing the song, in accordance with the current language associated with the first user's voice, as detected by the language detector detecting device; determining the current language of lyrics that should be displayed on the second mobile device when playing the song, in accordance with the current language associated with the second user's voice, as detected by the language detector detecting device of the second mobile device; mixing the music received from the centralized system with the background determined by the first mobile device and the lyrics associated with the current language; mixing the music received from the centralized system with the background determined by the second mobile device and the lyrics associated with the current language; playing the mixed music, together with the determined background and the determined lyrics, on the first mobile device; playing the mixed music, together with the determined background and the determined lyrics, on the second mobile device; allowing the first user to sing with the playing song; allowing the second user to sing with the playing song; determining whether the first user is singing too slowly, in view of speed of lyrics displayed on the first mobile device; determining whether the second user is singing too slowly, in view of speed of lyrics displayed on the second mobile device; if determined that the first user is singing too slowly, stopping playing the song on the first mobile device; adjusting the speed of lyrics displayed on the first mobile device and adjust speed of playing the mixed music; and continuing to play rest of song on the first mobile device with the adjusted speed of lyrics; if determined that the second user is singing too slowly, stopping playing the song on the second mobile device; adjusting the speed of lyrics displayed on the second mobile device and adjust speed of playing the mixed music; and continuing to play rest of song on the second mobile device with the adjusted speed of lyrics; determining whether the first user is changing language, in view of current language sung in the song by the first user; if determined that the first user has changed to another language, stopping playing the song on the first mobile device; notifying the central system to send the lyrics of the another language to the first mobile device; mixing the lyrics of the another language with the song; playing the rest of the mixed song to the first mobile device; determining whether the second user is changing language, in view of current language sung in the song by the second user; and if determined that the first user has changed to another language, stopping playing the song on the second mobile device; notifying the central system to send the lyrics of the another language to the second mobile device; mixing the lyrics of the another language with the song; playing the rest of the mixed song to the second mobile device.

What is claimed is:

1. A singing system for allowing multiple singers of different environments to join in a same song simultaneously, comprising:
a centralized system to control songs playing on different mobile devices;
a first mobile device held by a first user;
a second mobile device held by a second user;
a location detecting device included in the first mobile device to determine a background that should be displayed on the first mobile device;
a language detector included in the first mobile device to detect current language in accordance with the first user's voice;
a speed detector included in the first mobile device to detect current speed of song sung currently by the first user;
a processor; and
a memory storing instructions that cause the processor to execute a method.

2. The system of claim 1, wherein the method comprises:
receiving instructions to play a song;
fetching music associated with the song from the centralized system;
sending the music associated with the song to the first mobile device;
determining the background should be displayed on the first mobile device when playing the song, in accordance with the current location detected by the location detecting device;
determining the current language of lyrics that should be displayed on the first mobile device when playing the song, in accordance with the current language associated with the first user's voice, as detected by the language detector detecting device;
mixing the music received from the centralized system with the background determined by the first mobile device and the lyrics associated with the current language;
playing the mixed music, together with the determined background and the determined lyrics, on the first mobile device;
allowing the first user to sing with the playing song;
determining whether the first user is singing too slowly, in view of speed of lyrics displayed on the first mobile device; and
if determined that the first user is singing too slowly, adjusting the speed of lyrics displayed on the first mobile device and adjust speed of playing the mixed music.

3. The system of claim 1, wherein the method comprises:
receiving instructions to play a song;
fetching music associated with the song from the centralized system;
sending the music associated with the song to the first mobile device;
determining the background should be displayed on the first mobile device when playing the song, in accordance with the current location detected by the location detecting device;
determining the current language of lyrics that should be displayed on the first mobile device when playing the song, in accordance with the current language associated with the first user's voice, as detected by the language detector detecting device;
mixing the music received from the centralized system with the background determined by the first mobile device and the lyrics associated with the current language;
playing the mixed music, together with the determined background and the determined lyrics, on the first mobile device;
allowing the first user to sing with the playing song;
determining whether the first user is singing too slowly, in view of speed of lyrics displayed on the first mobile device;
if determined that the first user is singing too slowly, stopping playing the song on the first mobile device;
adjusting the speed of lyrics displayed on the first mobile device and adjust speed of playing the mixed music; and
continuing to play rest of song on the first mobile device with the adjusted speed of lyrics;
determining whether the first user is changing language, in view of current language sung in the song by the first user; and
if determined that the first user has changed to another language, stopping playing the song on the first mobile device;
notifying the central system to send the lyrics of the another language to the first mobile device;
mixing the lyrics of the another language with the song;
playing the rest of the mixed song to the first mobile device.

4. The system of claim 1, wherein the method comprises:
receiving instructions to play a song;
fetching music associated with the song from the centralized system;
sending the music associated with the song to the first mobile device;
sending the music associated with the song to the second mobile device;
determining the background should be displayed on the first mobile device when playing the song, in accordance with the current location detected by the location detecting device of the first mobile device;
determining the background should be displayed on the second mobile device when playing the song, in accordance with the current location detected by the location detecting device of the second mobile device;
determining the current language of lyrics that should be displayed on the first mobile device when playing the song, in accordance with the current language associated with the first user's voice, as detected by the language detector detecting device;
determining the current language of lyrics that should be displayed on the second mobile device when playing the song, in accordance with the current language associated with the second user's voice, as detected by the language detector detecting device of the second mobile device;
mixing the music received from the centralized system with the background determined by the first mobile device and the lyrics associated with the current language;
mixing the music received from the centralized system with the background determined by the second mobile device and the lyrics associated with the current language;
playing the mixed music, together with the determined background and the determined lyrics, on the first mobile device;
playing the mixed music, together with the determined background and the determined lyrics, on the second mobile device;
allowing the first user to sing with the playing song;
allowing the second user to sing with the playing song;
determining whether the first user is singing too slowly, in view of speed of lyrics displayed on the first mobile device;
determining whether the second user is singing too slowly, in view of speed of lyrics displayed on the second mobile device;
if determined that the first user is singing too slowly, stopping playing the song on the first mobile device;
adjusting the speed of lyrics displayed on the first mobile device and adjust speed of playing the mixed music; and
continuing to play rest of song on the first mobile device with the adjusted speed of lyrics;
if determined that the second user is singing too slowly, stopping playing the song on the second mobile device;
adjusting the speed of lyrics displayed on the second mobile device and adjust speed of playing the mixed music; and
continuing to play rest of song on the second mobile device with the adjusted speed of lyrics;
determining whether the first user is changing language, in view of current language sung in the song by the first user;
if determined that the first user has changed to another language, stopping playing the song on the first mobile device;
notifying the central system to send the lyrics of the another language to the first mobile device;
mixing the lyrics of the another language with the song;
playing the rest of the mixed song to the first mobile device;
determining whether the second user is changing language, in view of current language sung in the song by the second user; and
if determined that the first user has changed to another language, stopping playing the song on the second mobile device;
notifying the central system to send the lyrics of the another language to the second mobile device;
mixing the lyrics of the another language with the song;
playing the rest of the mixed song to the second mobile device.
